(19) United States
(12) Patent Application Publication
(10) Pub. No.: US 2006/0149548 A1
(43) Pub. Date: Jul. 6, 2006

(54) Speech input method and system for portable device

(75) Inventors: Ming-hong Wang, Hsinchu City (TW); Jia-lin Shen, Lujhou City (TW); Yuan-chia Lu, Hualien City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/087,233

(22) Filed: Mar. 23, 2005

(30) Foreign Application Priority Data
Dec. 31, 2004 (TW) 093141879

(51) Int. Cl. G10L 15/04

(52) U.S. Cl. 704/254

(57) ABSTRACT

In the present invention, a speech input method for the portable device is provided. The speech input method includes steps of (a) selecting a language mode and determining an acoustic unit, (b) inputting a speech by a user and comparing the speech with the acoustic unit to generate a plurality of recognition results, (c) selecting one of the recognition results for obtaining a plurality of keywords with a recognition result-to-keyword mapping table, (d) obtaining a plurality of selected results having the keywords therein from a database by using the keywords as search units, (e) repeating step (b) to step (d) so as to narrow a range of the selected results when a next speech is present, and (f) displaying the selected results in order when the next speech is absent.

### FIELD OF THE INVENTION

The present invention relates to a speech input method and system, and more particularly to a speech input method and system for the portable device.

### BACKGROUND OF THE INVENTION

Nowadays, the capacity of the storage medium is getting larger and larger and the price thereof is getting lower and lower, which makes the storage medium to be more popularized in the market. The portable device available in the market, such as the MP3 player and iPod, already has a large capacity capable of storing more than 200 songs. As a result, if the user wants to search a favorite song among the great amount of songs stored therein, the only way therefore is to press the keys on the portable device and scroll the songs shown on the monitor of the portable device one by one.

Usually, there is no interface for word input on the portable device. Also, in view of compactness, portability and simple operation, it is impossible to employ an additional keyboard or dispose too many keys on the portable device. Taking the MP3 player for example, if the user wants to search a favorite song, currently the only way therefor is to press the keys on the portable device and scroll the songs shown on the monitor of the portable device one by one. Such way is very inefficient if there are too many songs stored in the storage medium of the MP3 player. Therefore, the speech input method provides a convenient way to solve the above problems.

If the speech input function is able to be combined with the portable device for searching the songs stored therein, the user can find his favorite songs easily without having to press the keys on the portable device. Besides, such a portable device with the speech input function has distinctive features over the conventional one and possesses a high additional value.

Therefore, a novel speech input method and speech input system are developed and provided in the present invention. The particular design in the present invention not only solves the problems described above, but is also easy to be implemented. Thus, the present invention has the utility for the industry.

### SUMMARY OF THE INVENTION

In accordance with one aspect of the present invention, a speech input method and a relevant system for the portable device are provided. The speech input system is able to support the function of multi-lingual input. Furthermore, a proper acoustic unit can be selected by the speech input system based on existing hardware, such as the CPU and the memory.

In accordance with another aspect of the present invention, a speech input method and a relevant system for the portable device are provided. In the speech input system, the acoustic unit is separate from the search unit. It is not necessary to supply all lexicons and the database can be expanded unlimitedly.

In accordance with a further aspect of the present invention, a speech input method and system for the portable device are provided. The portable device is capable of being connected to a remote server via the wireless network to access the database of the remote server. In this way, not only the capacity of the database in the portable device can be economized, but the efficiency thereof can be enhanced.

In accordance with further another aspect of the present invention, a speech input method for a portable device is provided. The speech input method includes steps of (a) selecting a language mode and determining an acoustic unit, (b) inputting a speech by a user and comparing the speech with the acoustic unit to generate a plurality of recognition results, (c) selecting one of the recognition results for obtaining a plurality of keywords with a recognition result-to-keyword mapping table, (d) obtaining a plurality of selected results having the keywords therein from a database by using the keywords as search units, (e) repeating step (b) to step (d) so as to narrow a range of the selected results when a next speech is present, and (f) displaying the selected results in order when the next speech is absent.

Preferably, the portable device is a player.

Preferably, the acoustic unit is one selected from a group consisting of a phonetic symbol, a syllable, a word and a letter.

Preferably, the search units are keywords selected from a group consisting of syllables without a tone, syllables with a tone, words and letters corresponding to the acoustic unit.

Preferably, the acoustic unit is generated by a multi-lingual unit.

Preferably, the acoustic unit is determined by the multi-lingual unit based on the language mode.

Preferably, the recognition result-to-keyword mapping table is a syllable-to-character mapping table.

Preferably, the recognition result-to-keyword mapping table is a character-to-character mapping table.

In accordance with further another aspect of the present invention, a speech input system for a portable device is provided. The speech input device includes a multi-lingual unit for determining an acoustic unit for a language mode selected by a user, a database for storing data, and a mapping table for storing a plurality of keywords which are based on a comparison result of at least one speech inputted by the user with the acoustic unit, wherein a plurality of selected results are generated by searching the database in response to the keywords.

Preferably, the portable device is a player.

Preferably, the acoustic unit is one selected from a group consisting of a phonetic symbol, a syllable, a word and a letter.

Preferably, the data are song files.

Preferably, the mapping table is a syllable-to-character mapping table.

Preferably, the mapping table is a character-to-character mapping table.

Preferably, the selected results are song files stored in the database.

Preferably, the speech input system is further connected to a remote server via a wireless network for accessing a database of the remote server.

In accordance with further another aspect of the present invention, a speech input method for a portable device is provided. The speech input method includes steps of (a) selecting a language mode and determining an acoustic unit, (b) inputting a speech by a user and comparing the speech with the acoustic unit to generate a plurality of recognition results, (c) selecting one of the recognition results as a search unit for searching a database so as to obtain a plurality of selected results having the search unit therein, (d) repeating step (b) to step (c) so as to narrow a range of the selected results when a next voice is present, and (e) displaying the selected results in order when the next speech is absent.

Preferably, the portable device is a player.

Preferably, the acoustic unit is one selected from a group consisting of a word and a letter.

Preferably, the search unit is one selected from a group consisting of a word and a letter.

Preferably, the acoustic unit is generated by a multi-lingual unit.

Preferably, the acoustic unit is determined by the multi-lingual unit based on the language mode.

In accordance with further another aspect of the present invention, a speech input system for a portable device is provided. The speech input system includes a multi-lingual unit for determining an acoustic unit for a language mode selected by a user; and a database for storing data, wherein a plurality of selected results are generated by searching the database in response to a comparison result of at least one speech inputted by the user with the acoustic unit.

Preferably, the comparison result is a search unit for searching the database so as to generate the selected results.

Preferably, the search unit is one selected from a group consisting of syllables without a tone, syllables with a tone, words and letters corresponding to the acoustic unit.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a flow chart of the speech input method for the portable device according to a preferred embodiment of the present invention;

FIG. 2 shows the connection of the portable device of the present invention with a remote server via the wireless network;

FIG. 3 is a flow chart of the speech input method for the portable device according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

In the present invention, the acoustic unit is used for the speech input recognition. Taking English for example, the letter is applied to the acoustic unit. Whereas, the phonetic symbol and the syllable can be adopted as the acoustic unit in the Chinese system. Due to the increase of more and more new songs and singers as well as the limitation of the computing capability and the memory size for the portable device, all databases can be covered under limited hardware resources with the employment of the acoustic unit for the speech input recognition. However, the “word” can be considered as the acoustic unit if the hardware resources are sufficient.

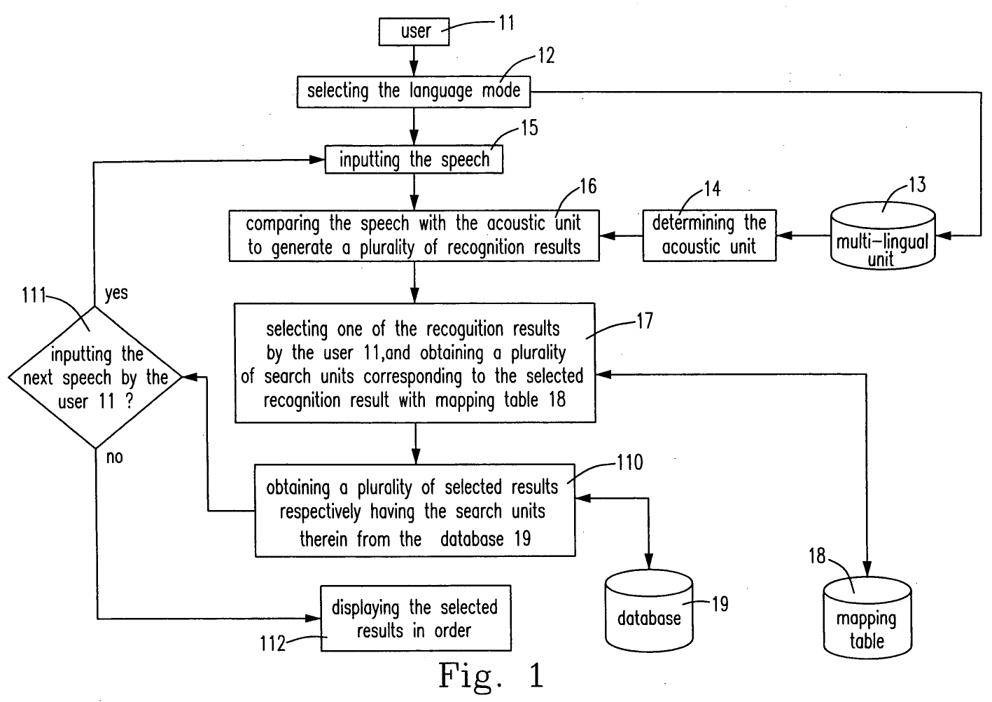

Please refer to FIG. 1, which shows a flow chart of the speech input method for the portable device according to a preferred embodiment of the present invention. At first, a language mode is selected by the user 11 through the keys on the portable device or via a speech input (step 12). The language mode could be Chinese, English, Japanese, etc. Meanwhile, the acoustic unit is determined by the multi-lingual unit 13 based on the language mode (step 14). Next, a speech is inputted by the user 11 (step 15). The speech is compared with the acoustic unit to generate a plurality of recognition results (step 16). Then, one of the recognition results is selected by the user 11 for obtaining a plurality of search units corresponding to the selected recognition result with the mapping table 18 (step 17). After that, a plurality of selected results respectively having the search units therein are obtained from the database 19 (step 110). In the meantime, the user 11 can decide whether to input a next speech or not (step 111). The process proceeds back to step 15 when the next speech is inputted by the user 11, so that the range of the selected results is narrowed down and finally aimed at an accurate result, e.g. a desired song or singer. Otherwise, the selected results are displayed in order if the user 11 does not input a next speech (step 112).

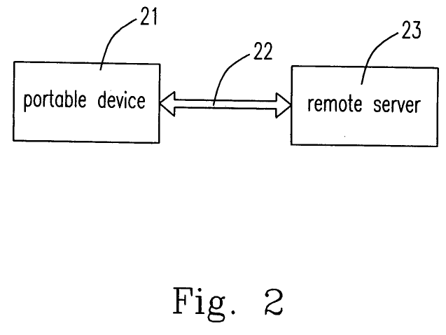

The mapping table 18 is a recognition result-to-keyword mapping table, so that the keywords are acquired therefrom based on the selected recognition result for searching the selected results within the database 19. Preferably, the mapping table 18 is a syllable-to-character mapping table or a character-to-character mapping table. All song files are stored in the database 19. Referring now to FIG. 2, which shows the connection of the portable device of the present invention with a remote server via the wireless network. As show in FIG. 2, the portable device 21 of the present invention is further connected to the remote server 23 via the wireless network 22 for accessing the database thereof. This not only saves the database size of the portable device 21 but enhances the efficiency thereof. The above-mentioned method will be clearly illustrated in the following Examples 1 and 2 respectively.

### EXAMPLE 1

Assume that the user wants to search a Chinese song, provided that the phonetic symbols serve as the acoustic unit and the Chinese character corresponding to the syllable without a tone serves as the search unit. If the user wants to listen to [symbol] (a Chinese song)” by [symbol] a Chinses signer)”, the steps for searching it are as follows.

(a) The user speaks [symbol] (one of the phonetic symbols for [symbol] ).

(b) Among the recognition results [symbol] the user selects [symbol] .

(c) The user then speaks [symbol] .

(d) Refer to the syllable-to-character mapping table, and the following Chinese characters are found out:

[symbol] [symbol] [symbol] [symbol] (Chinese characters)”.

(e) A list of the song files containing the above Chinese characters is displayed:

[symbol] [symbol] [symbol] [symbol] [symbol] [symbol] [symbol] [symbol] [symbol] [symbol] [symbol] [symbol] (singer-song)”.

(f) At this time, the user can press the keys on the portable device to choose the song he wants to listen to, or inputs the next speech to further narrow the range of the selected results.

For example, the user speaks [symbol] (one of the phonetic symbols for

[symbol]

Among the recognition results [symbol] the user selects

[symbol]

Refer to the syllable-to-character mapping table, and the following Chinese characters are found out:

[symbol] [symbol] (Chinese characters)”.

A list of the song files containing the above Chinese characters is displayed:

[symbol] [symbol] [symbol] (singer-song)”.

### EXAMPLE 2

Assume that the user wants to search a Chinese song, provided that the syllable serves as the acoustic unit and the Chinese character corresponding to the syllable with a tone serves as the search unit. If the user wants to listen to [symbol] (a Chinese song)” by [symbol] (a Chinese signer)”, the steps for searching it are as follows.

(a) the user speaks [symbol] (the phonetic symbol for [symbol] with the tone of [symbol] ).

(b) Among the recognition results [symbol] the user selects

[symbol]

(c) Refer to the syllable-to-character mapping table, and the following Chinese characters are found out:

[symbol] [symbol] (Chinese characters)”.

(d) A list of the song files containing the above Chinese characters is displayed:

[symbol] [symbol] [symbol] [symbol] [symbol] [symbol] [symbol] [symbol] (singer-song)”.

(e) At this time, the user can press the keys on the portable device to choose the song he wants to listen to, or inputs the next speech to further narrow the range of the selected results.

For example, the user speaks [symbol] (the phonetic symbol for [symbol] with the tone of

[symbol]

Among the recognition results [symbol] the user selects

[symbol]

Refer to the syllable-to-character mapping table, and the following Chinese characters are found out:

[symbol] [symbol] (Chinese characters)”.

A list of the song files containing the above Chinese characters is displayed:

[symbol] [symbol] (singer-song)”.

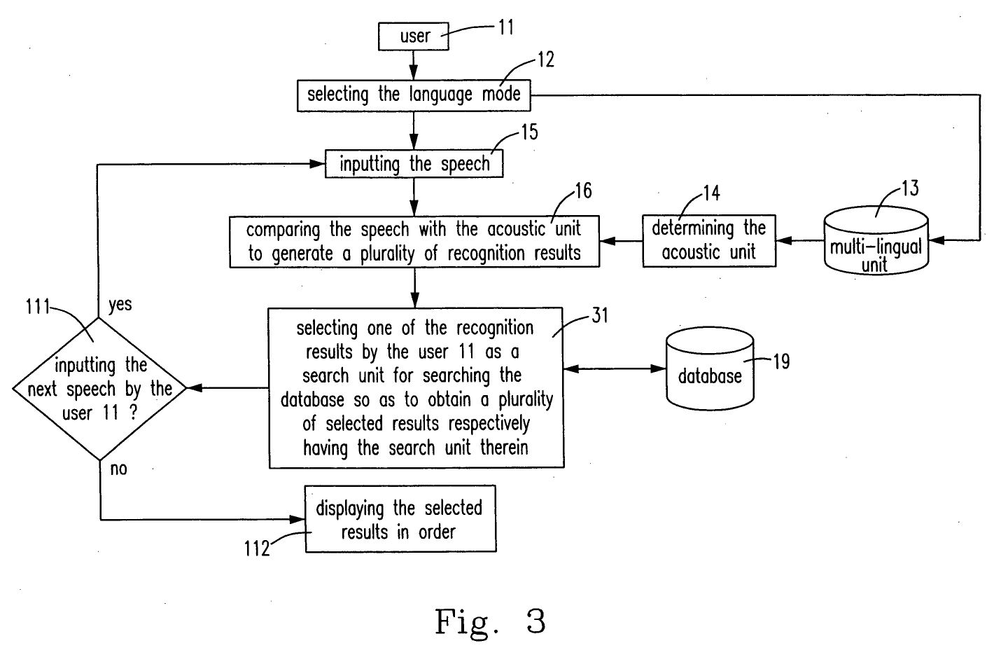

Please refer to FIG. 3, which shows the flow chart of the speech input method for the portable device according to another preferred embodiment of the present invention. At first, a language mode is selected by the user 11 through the keys on the portable device or via a speech input (step 12). The language mode could be Chinese, English, Japanese, etc. Meanwhile, the acoustic unit is determined by the multi-lingual unit 13 based on the language mode (step 14). Next, a speech is inputted by the user 11 (step 15). The speech is compared with the acoustic unit to generate a plurality of recognition results (step 16). Then, one of the recognition results is selected by the user 11 as a search unit for searching the database 19 so as to obtain a plurality of selected results respectively having the search unit therein (step 31). In the meantime, the user 11 can decide whether to input a next speech or not (step 111). The process proceeds back to step 15 when the next speech is inputted by the user 11, so that the range of the selected results is narrowed down and finally aimed at an accurate result, e.g. a desired song or singer. Otherwise, the selected results are displayed in order if the user 11 does not input a next speech (step 112). The above-mentioned method will be clearly illustrated in the following Examples 3-5 respectively.

### EXAMPLE 3

Assume that the user wants to search a English song, provided that the English letter serves as the acoustic unit as well as the search unit. If the user wants to listen to “Can't Fight The Moonlight” by “LeAnn Rimes”, the steps for searching it are as follows.

(a) The user speaks “L”.

(b) Among the recognition results “l”, “a”, “r”, the user selects “l”.

(c) Refer to the character-to-character mapping table, and the following English characters are found out:

[symbol]

(d) A list of the song files containing “L” or “l” at the head thereof (like looking up English vocabulary with the electronic dictionary) is displayed.

(e) The user selects the song files containing “L” at the head thereof. At this time, the user can input the next speech to further narrow the range of the selected results.

### EXAMPLE 4

Assume that the user wants to search a Chinese song, provided that the word serves as the acoustic unit as well as the search unit. If the user wants to listen to [symbol] (a Chinese song)” by [symbol] (a Chinese singer)”, the steps for searching it are as follows.

(a) the user speaks

[symbol]

(b) Among the recognition results [symbol] (all are Chinese singers), the user selects

[symbol]

(c) Search the song files containing [symbol] from the database and list the results.

(d) At this time, the user can press the keys on the portable device to choose the song he wants to listen to, or inputs the next speech to further narrow the range of the results.

### EXAMPLE 5

Assume that the user wants to search a Japanese song, provided that the Japanese phonetic symbol serves as the acoustic unit, and the HIRAGANA or the KATAKANA serves as the search unit.

For example, the user speaks “ka”, and a plurality of recognition results could be [symbol] etc. Then, the user selects [symbol] and the song files with the titles containing [symbol] are searched from the database. At this time, the user can press the keys on the portable device to choose the song he wants to listen to, or inputs the next speech to further narrow the range of the selected results.

In conclusion, the present invention has the following features and advantages over the prior art.

1. The speech input system and method of the present invention are able to support the function of multi-lingual input.

2. A proper acoustic unit can be selected by the speech input system of the present invention based on existing hardware, such as the CPU and the memory.

3. In the present invention, the acoustic unit is separate from the search unit. It is not necessary to supply all lexicons and the database can be expanded unlimitedly.

4. The portable device of the present invention is capable of being connected to a remote server via the wireless network to access the database of the remote server. In this way, not only the capacity of the database in the portable device can be economized, but the efficiency thereof can be enhanced.

Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A speech input method for a portable device, comprising steps of:
(a) selecting a language mode and determining an acoustic unit;
(b) inputting a speech by a user and comparing said speech with said acoustic unit to generate a plurality of recognition results;
(c) selecting one of said recognition results for obtaining a plurality of keywords with a recognition result-to-keyword mapping table;
(d) obtaining a plurality of selected results having said keywords therein from a database by using said keywords as search units;
(e) repeating step (b) to step (d) so as to narrow a range of said selected results when a next speech is present; and
(f) displaying said selected results in order when said next speech is absent.

2. The speech input method as claimed in claim 1, wherein said portable device is a player.

3. The speech input method as claimed in claim 1, wherein said acoustic unit is one selected from a group consisting of a phonetic symbol, a syllable, a word and a letter.

4. The speech input method as claimed in claim 3, wherein said search units are keywords selected from a group consisting of syllables without a tone, syllables with a tone, words and letters corresponding to said acoustic unit.

5. The speech input method as claimed in claim 1, wherein said acoustic unit is generated by a multi-lingual unit.

6. The speech input method as claimed in claim 5, wherein said acoustic unit is determined by said multi-lingual unit based on said language mode.

7. The speech input method as claimed in claim 1, wherein said recognition result-to-keyword mapping table is a syllable-to-character mapping table.

8. The speech input method as claimed in claim 1, wherein said recognition result-to-keyword mapping table is a character-to-character mapping table.

9. A speech input system for a portable device, comprising:
a multi-lingual unit for determining an acoustic unit for a language mode selected by a user;
a database for storing data; and
a mapping table for storing a plurality of keywords, providing that a comparison result of at least one speech inputted by said user with said acoustic unit is converted into corresponding keywords therethrough;
wherein a plurality of selected results are generated by searching said database in response to said corresponding keywords.

10. The speech input system as claimed in claim 9, wherein said portable device is a player.

11. The speech input system as claimed in claim 9, wherein said acoustic unit is one selected from a group consisting of a phonetic symbol, a syllable, a word and a letter.

12. The speech input system as claimed in claim 9, wherein said data are song files.

13. The speech input system as claimed in claim 9, wherein said mapping table is a syllable-to-character mapping table.

14. The speech input system as claimed in claim 9, wherein said mapping table is a character-to-character mapping table.

15. The speech input system as claimed in claim 9, wherein said selected results are song files stored in said database.

16. The speech input system as claimed in claim 9, further being connected to a remote server via a wireless network for accessing a database of said remote server.

17. A speech input method for a portable device, comprising steps of:
(a) selecting a language mode and determining an acoustic unit;
(b) inputting a speech by a user and comparing said speech with said acoustic unit to generate a plurality of recognition results;
(c) selecting one of said recognition results as a search unit for searching a database so as to obtain a plurality of selected results having said search unit therein;
(d) repeating step (b) to step (c) so as to narrow a range of said selected results when a next voice is present; and
(e) displaying said selected results in order when said next speech is absent.

18. The speech input method as claimed in claim 17, wherein said portable device is a player.

19. The speech input method as claimed in claim 17, wherein said acoustic unit is one selected from a group consisting of a word and a letter.

20. The speech input method as claimed in claim 19, wherein said search unit is one selected from a group consisting of a word and a letter.

21. The speech input method as claimed in claim 17, wherein said acoustic unit is generated by a multi-lingual unit.

22. The speech input method as claimed in claim 21, wherein said acoustic unit is determined by said multi-lingual unit based on said language mode.

23. A speech input system for a portable device, comprising:
a multi-lingual unit for determining an acoustic unit for a language mode selected by a user; and
a database for storing data;
wherein a plurality of selected results are generated by searching said database in response to a comparison result of at least one speech inputted by said user with said acoustic unit.

24. The speech input system as claimed in claim 23, wherein said comparison result is a search unit for searching said database so as to generate said selected results.

25. The speech input system as claimed in claim 24, wherein said search unit is one selected from a group consisting of syllables without a tone, syllables with a tone, words and letters corresponding to said acoustic unit.
